(19) United States
(12) Patent Application Publication
(10) Pub. No.: US 2007/0012129 A1
(43) Pub. Date: Jan. 18, 2007

(54) Adjustable flange arrangement for synchronization of multiple generators

(75) Inventors: Ronald P. Maty, Chandler, AZ (US); Christopher J. Herlihy, Scottsdale, AZ (US); Edward M. Brady, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC.

(21) Appl. No.: 11/181,183

(22) Filed: Jul. 13, 2005

(51) Int. Cl. F16H 35/08

(52) U.S. Cl. 74/395

(57) ABSTRACT

An adjustable flange is provided by the present invention for the synchronization of multiple generators driven by a gas turbine engine. The adjustable flange of the present invention may comprise a clocking pin and a plurality of alignment holes which may allow for the precise synchronization of the generators so that they may be driven in a precisely parallel manner. The adjustable flange may be used, for example, in combination with any gas turbine engine having multiple gearbox-mounted generators, such as the engines used in gas turbine-driven land vehicles, or with any other source of rotating-shaft power suitable to drive the gearbox. A method for using the adjustable flange to synchronize multiple generators of an engine is also provided.

### GOVERNMENT RIGHTS

This invention was made with Government support under contract no. F19628-03-C-0014 awarded by the United States Air Force. The Government has certain rights in this invention.

### BACKGROUND OF THE INVENTION

This invention generally relates to synchronization of multiple generators and more specifically to a flange that allows precise adjustment in synchronizing the drive shafts of multiple generators.

Engines having multiple, gearbox-mounted generators often require the generator drive gears in the gearbox to be phased to the generator rotor position for efficient delivery of generated power. The multiple generators are driven through a series of gears that allow increasing or decreasing engine output speed to the necessary generator input speed. Each individual generator stator has to be in precisely the same position relative to its rotor as all the other generators. The synchronization of the other generators back to the one position selected to be the reference generator is required at all operating conditions, including variable and independent loading of each generator, as well as extremely hot and cold temperatures. These conditions have an impact on the position of the gear teeth relative to their mating gears, as do the inherent errors of tooth index and runout that are obtained in reasonable manufacturing tolerance requirements. These elements will consume much of the allowed positioning tolerance of the generators. Therefore, the connection to the generator shaft and timing indication needs to be extremely precise. This requires all the gears in the drive train to be synchronized as well, since they are attached to the generators. The gearbox is required to provide an interface to each generator that drives the generator rotors in phase by referencing timing indications of the generators.

Most of the gear arrangements and methods of synchronization of multiple drive shafts of the prior art require excessive precision machining. This can be time consuming, difficult and expensive, especially when more than two rotating shafts are involved. For example, U.S. Pat. Nos. 4,691,119 and 6,304,002 describe methods to drive multiple generators that include rotating the generator housing to maintain constant frequency. Neither the '119 nor the '002 patent allows for precise synchronization of multiple generator stators to their rotors.

As can be seen, there is a need for apparatus and methods that allow for precise synchronization of rotating drive shafts of multiple generators, preferably prior to engine operation, and particularly during manufacture of the engine.

### SUMMARY OF THE INVENTION

In one aspect of the present invention there is provided an adjustable flange for synchronizing multiple generators comprising a body; a clocking pin, the clocking pin being attached to the body; and a plurality of alignment holes, the plurality of alignment holes being disposed circumferentially around the body.

In another aspect of the present invention there is provided an adjustable flange for synchronizing multiple generators comprising a circular body; a clocking pin, the clocking pin being attached to the circular body; a plurality of bolt slots, the plurality of bolt slots being disposed circumferentially around the circular body; and a plurality of alignment holes, the plurality of alignment holes being disposed circumferentially around the circular body between the bolt holes.

In yet another aspect of the present invention there is provided an adjustable flange for synchronizing multiple generators comprising a circular body; a clocking pin, the clocking pin projecting axially from a forward face of the circular body; a plurality of bolt slots, the plurality of bolt slots being disposed circumferentially around the circular body[0]; a plurality of alignment holes, the plurality of alignment holes being disposed circumferentially around the circular body and wherein each of the alignment holes has a different off-set angle relative to a corresponding one of a plurality of threaded insert holes on the gearbox, wherein the off-set angle progressively increases by a defined increment for each successive pair of alignment holes and threaded insert holes; and at least one oil passage, the oil passage being disposed through the circular body.

In a further aspect of the present invention there is provided an adjustable flange for synchronizing a gearbox to a generator comprising: a circular body; a clocking pin, the clocking pin projecting axially from a forward face of the circular body, wherein the clocking pin aligns with the generator; a plurality of bolt slots, the plurality of bolt slots being disposed circumferentially around the circular body, wherein the plurality of bolt slots align with a plurality of bolt holes on the generator and gearbox; a plurality of alignment holes, the plurality of alignment holes being disposed circumferentially around the circular body, wherein each of the alignment holes has a different off-set angle relative to a corresponding one of a plurality of threaded insert holes on the gearbox, wherein the off-set angle progressively increases by a defined increment for each successive pair of alignment holes and threaded insert holes; and at least one oil passage, the oil passage being disposed through the circular body, wherein the oil passage is located at 90 degrees or 180 degrees relative to the clocking pin.

In still another aspect of the present invention there is provided an engine comprising a plurality of generators; a gearbox, the gearbox comprising a plurality of generator drive gears, wherein each generator drive gear drives one of said generators; and a plurality of adapter flanges, wherein each of the adapter flanges aligns each generator with each gear drive train, and wherein each of the adapter flanges synchronizes a corresponding one of the generators such that the generators are synchronized to one another.

In yet a further aspect of the present invention there is provided a method for synchronizing multiple generators of an engine comprising the steps of a) inserting a primary generator drive gear into the gearbox, b) inserting a generator clocking pin of an adjustable flange into a suitable gauge or fixture; c) positioning the generator clocking pin at a desired angular position relative to a clocking feature of a generator drive spline by rotating the adjustable flange with the gauge or fixture, wherein the generator drive spline is part of a generator gear; d) securing the adjustable flange to the generator housing and the gearbox with a single clocking bolt after obtaining the desired angular position; e) inserting a secondary generator drive gear by engaging the gear teeth of the secondary drive gear with the complementary mating gear at the position that aligns the spline clocking feature closest to the desired location; f) positioning the generator clocking pin of the secondary adjustable flange relative to the clocking feature of the corresponding secondary generator drive spline with a second suitable gage or fixture; g) securing the secondary adjustable flange to the gearbox and h) repeating steps a) to g) for each subsequent generator location of the engine until all generators are synchronized.

These and other features, aspects and advantages of the present invention will become better understood with reference to the following drawings, description and claims.

### BRIEF DESCRIPTION OF THE DRAWINGS

FIG. 1 is a cross-sectional view of a gas turbine engine according to the present invention;

FIG. 2 is a cross-sectional view of a gearbox and an adjustable flange of the gas turbine engine of FIG. 1, according to the present invention;

FIG. 3 is a forward view of an adjustable flange, according to the present invention;

FIG. 4 is an expanded view of the adjustable flange of FIG. 3, according to another embodiment of the present invention; and

FIG. 5 is a flow chart for a method of synchronization of multiple generators, according to a further embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, an adjustable flange is provided by the present invention for the synchronization of multiple generators driven by a gas turbine engine. According to the application, some gas turbine engines may have multiple generators which may be mounted on a single gearbox. For efficient power generation, it may be desirable to synchronize the generators such that they are driven in a precise parallel manner. The adjustable flange of the present invention may allow for the precise synchronization of the generators so that they may be driven in a precisely parallel manner. The adjustable flange may be used, for example, in combination with any gas turbine engine having multiple gearbox-mounted generators, such as the engines used in gas turbine-driven land vehicles.

Currently in the prior art, the synchronization of multiple generators in gas turbine engines and other applications may be accomplished by adjusting the relative axial position of a helical gear. This adjustment may have to be done after the engine is assembled and while the engine is running, which may be awkward and time consuming. Additionally, precise synchronization may require precision manufacturing of the helical gears and other engine parts and excessive face width of the gears if a large value of angular adjustment is required. The greater the number of multiple generators, the more difficult it may be to precisely synchronize the generators. The adjustable flange of the present invention may eliminate these deficiencies as it may allow the precise alignment of each generator with the gear arrangement in the gearbox, resulting in the synchronization of multiple generators. The present invention may provide precise synchronization for engines having greater than two generators, by providing alignment of a generator clocking pin with a clocking feature of a generator drive spline in the gearbox. The precise alignment of the generator clocking pin and the clocking feature to an angle predetermined for the desired engine may allow for more precise synchronization than the axial adjustment of a helical gear. Furthermore, the present invention may allow for the precise synchronization of the generators at assembly so that all of the generators may be driven in a precisely parallel manner without incorporating excessive precision manufacturing requirements for all the gears and parts involved.

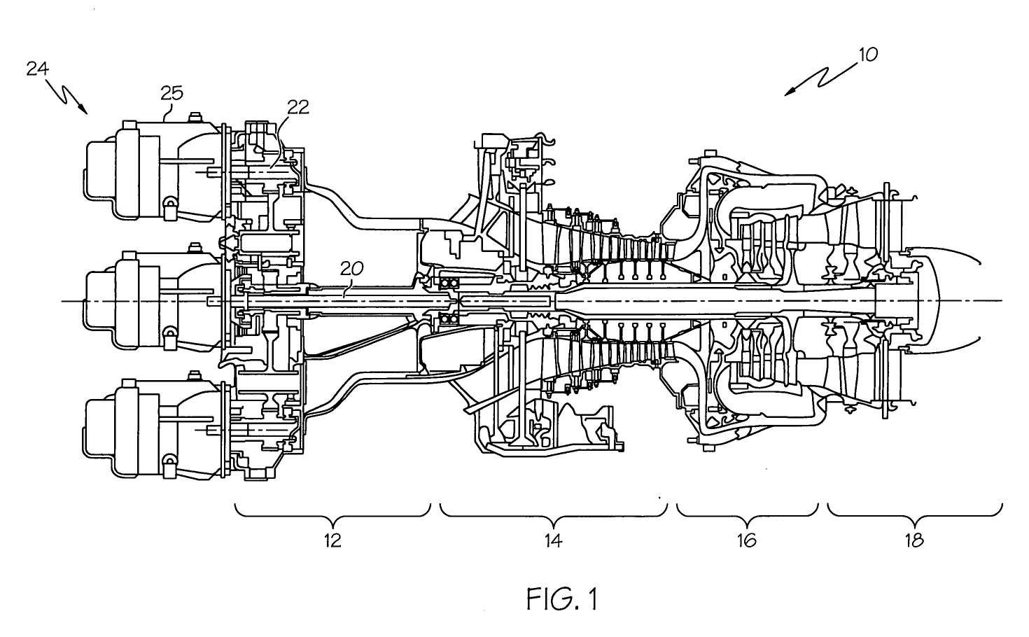

Illustrated in FIG. 1 is a cross-section of a gas turbine engine 10 where the gas turbine engine 10 may be coupled to multiple generators 24. Gas turbine engine 10 may be coupled to at least two generators 24, wherein all of generators 24 may be mounted on a single gearbox 12. Although the gas turbine engine 10 illustrated in FIG. 1 shows three gearbox-mounted generators 24, it is contemplated that gas turbine engine 10 may have any number of gearbox-mounted generators 24. In an illustrative embodiment, gas turbine engine 10 may have six gearbox-mounted generators 24. Gas turbine engine 10 may further comprise a gas generator 14, a combustor module 16, and a turbine module 18 which are connected to the generator 24 through an engine quill shaft 20 in gearbox 12. The engine quill shaft 20 may drive each generator 24 individually through a series of gears to drive gear shaft 22 of gearbox 12. It is further contemplated that the gas turbine engine powering the gearbox may be any suitable source of rotating-shaft power, such as, but not limited to, other types of internal-combustion engines or other power sources such as sea or wind turbines.

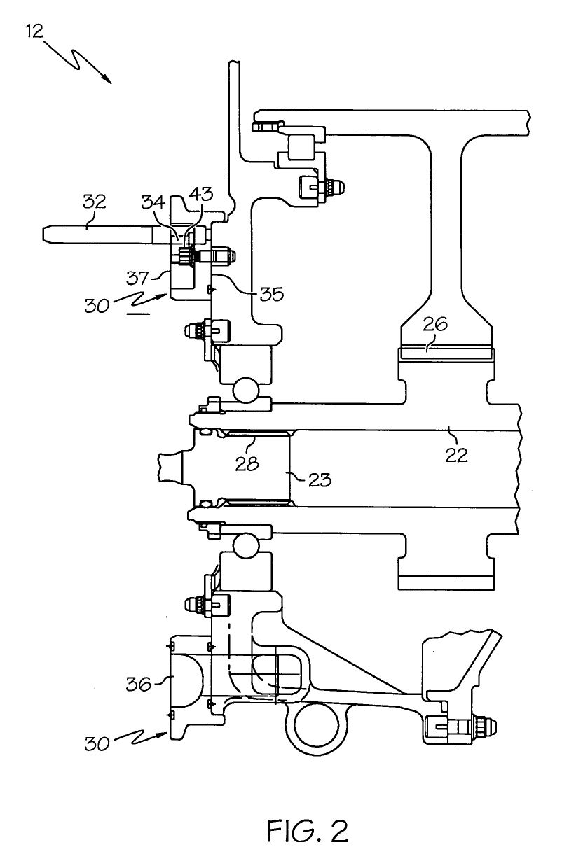

Referring to FIG. 2, there is shown an adjustable flange 30 secured to gearbox 12 on an aft face 35 of adjustable flange 30 by an alignment bolt 43. Although not shown, adjustable flange 30 may be also secured to generator 24 on a forward face 37 of adjustable flange 30. It is contemplated that adjustable flange 30 may be used to synchronize any plurality of generator drive gears, such as generator drive gear 26 of a gearbox, such as gearbox 12, with their corresponding generators, such as generator 24. As illustrated in FIG. 2, gearbox 12 may comprise drive gear shaft 22 where drive gear shaft 22 may comprise a generator drive gear 26 which connects engine quill shaft 20 to drive gear shaft 22. Drive gear shaft 22 may further comprise generator drive spline 28 which may couple drive gear shaft 22 to an external spline (not shown) of a generator drive shaft 23, where generator drive shaft 23 may be connected to generator 24. The external spline of generator drive shaft 23 may incorporate a clocking feature, such as a missing tooth, which may engage a filled-in tooth on the generator drive spline 28. Alternate examples of clocking features may be an oversized tooth or key. The number of drive gear shafts 22 may be the same as the number of generators 24. Adjustable flange 30 may be attached to gearbox 12, aligning gearbox 12 with generator 34. The number of adjustable flanges 30 may be the same as the number of generators 24. Alternatively, adjustable flange 30 may be used with the adjustable gear arrangement of commonly assigned U.S. patent application Ser. No. 10/994,900, hereby incorporated by reference.

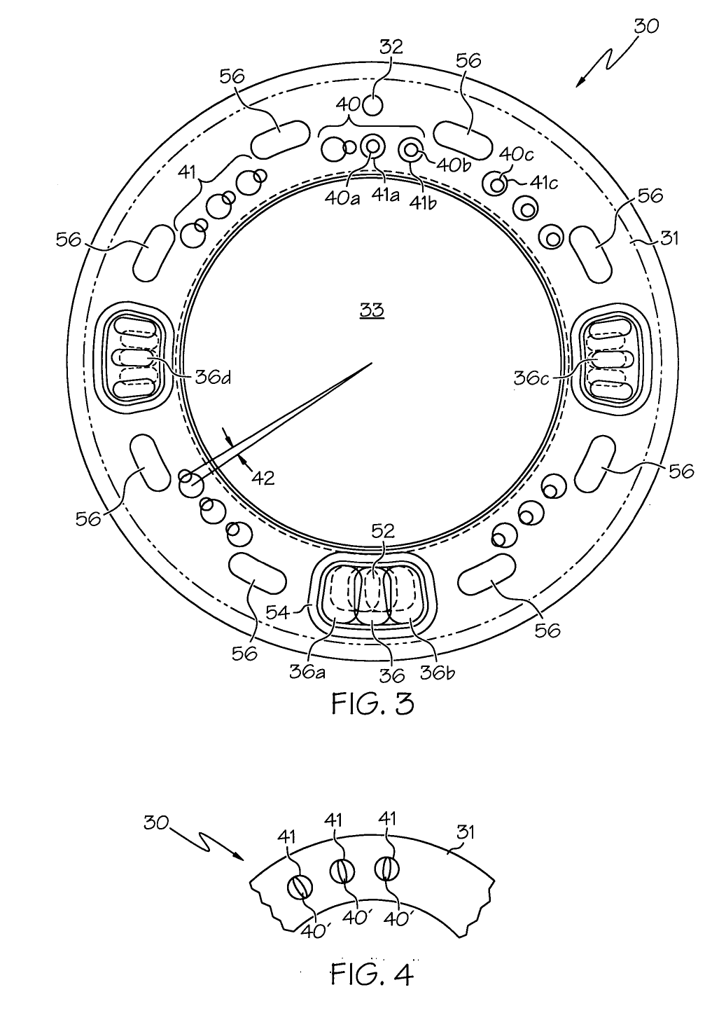

Adjustable flange 30 is shown in greater detail in FIG. 3. Adjustable flange 30 may comprise a body 31 where body 31 may have opening 33 sufficient to allow generator drive shaft 23 to pass through adjustable flange 30 from gearbox 12 to generator 24 while allowing for rotation of generator drive shaft 23. In an illustrative embodiment, body 31 may have a circular shape. Adjustable flange 30 may also comprise a generator clocking pin 32 for aligning adjustable flange 30 with generator 24 where generator clocking pin may project axially from a forward face 37 of adjustable flange 30. Generator clocking pin 24 may be positioned on forward face 37 of adjustable flange 30 facing generator 24 so that clocking pin 24 may be inserted into an opening in a generator housing 25 of generator 24. It is understood alternatively that the clocking pin may be attached to the generator 24 and the mating hole be in adjustable flange 30. Adjustable flange 30 may further comprise a plurality of bolt slots 56 circumferentially disposed on adjustable flange 30 for attaching adjustable flange 30 to generator 24 and gearbox 12. Bolt slots 56 may be recessed in forward face 37 of body 31 and may have dimensions to accommodate the desired bolt size. Bolt slots 56 may be designed to allow adjustable flange 30 to be rotated either clockwise or counterclockwise relative to gearbox 12. In one illustrative embodiment, adjustable flange 30 may comprise from about 6 to about 8 bolt slots 56.

Adjustable flange 30 may further comprise a plurality of alignment holes 40 disposed circumferentially around body 31 between bolt slots 56. Each of the plurality of alignment holes 40 may correspond to one of a plurality of threaded insert holes, 41 on gearbox 12. Alignment holes 40 may each be at a slightly different angular location, relative to the corresponding threaded insert holes 41 on gearbox 12, from each other, where an off-set angle 42 increases progressively by a defined increment. By way of non-limiting example, off-set angle 42 may increase progressively by from about 0.2 degrees to about 0.3 degrees. Referring to FIG. 3, as a non-limiting example, when alignment hole 40a aligns directly with no offset with respect to threaded insert hole 41a, then alignment hole 40b may have an off-set angle of 0.3 degrees with respect to threaded insert hole 41b, and alignment hole 40c may have an off-set angle 42 of 0.6 degree with respect to threaded insert hole 41c. The illustrative adjustable flange 30 of FIG. 3 may have a total of 15 alignment holes so therefore, the last, or fifteenth alignment hole 40, moving clockwise from alignment hole 40a, may have an off-set angle 42 of 4.2 degrees with respect to its corresponding threaded insert hole 41. The first hole may be aligned and thus there may be only 14 adjusting holes. Multiplying 14 adjusting holes by an offset of 0.3 degrees each may result in an offset of 4.2 degrees for the last hole. Therefore, adjustable flange 30 may be rotated by 14×0.3 degrees or a total angle of 4.2 degrees in 0.3 degree increments with respect to gearbox 12 to precisely align generator clocking pin 32 at a proper angular position relative to a clocking feature of generator drive spline 28. Each individual model of gas turbine engine 10 will have a predetermined optimal angular alignment between generator clocking pin 32 and the clocking feature of generator drive spline 28. In one illustrative embodiment, generator clocking pin 32 is aligned at an angle of 135° with respect to the clocking feature of generator drive spline 28. In an alternative illustrative embodiment (not shown), there may be about 20 alignment holes 40 where the angular difference may successively increase by 0.2 degree increments with each successive alignment hole 40. Therefore, adjustable flange 30 may be rotated by 20×0.2 degrees or a total angle of 4.0 degrees in 0.2 degree increments with respect to gearbox 12 to precisely align generator clocking pin 32 at a proper angular position relative to the clocking feature generator drive spline 28. It will be appreciated that the number of alignment holes 40, and the angular difference between alignment holes 40 and their corresponding insert hole 41 may depend on the degree of alignment precision required between gearbox 12 and generator 24 and/or the physical dimensions of adjustable flange 30 and/or gearbox 12.

The total angle that adjustable flange 30 may be rotated clockwise or counterclockwise may be at least as large as one-half the tooth-to-tooth angle of generator drive gear 26 (see FIG. 2). Therefore, in another illustrative embodiment, a generator drive gear may have 59 teeth, yielding a tooth-to-tooth angle of 360÷59 or 6.10 degrees between teeth. The angular difference between alignment holes 40 may then be at least half of 6.10 degrees or 3.05 degrees. In a further illustrative embodiment, using the adjustable flange of FIG. 3 described above, a generator drive gear may have 43 teeth with the angular difference between alignment holes 40 being at least 360÷(2×43) or 4.14 degrees. It will be appreciated that an adjustable flange 30 having the arrangement of alignment holes 40 of either of the illustrative embodiments given above may be used with the generator drive gear 26 having 43 teeth or 59 teeth respectively.

The rotational position of adjustable flange 30 may be determined by which alignment hole 40 aligns with which threaded insert hole 41. Rotation of adjustable flange 30 may be in a clockwise or counterclockwise direction. By way of non-limiting example, generator drive spline 28 may be perfectly oriented and no adjustment of adjustable flange 30 will be necessary. In another non-limiting example, generator drive gear 26 may be halfway between positions, or half of the tooth-to-tooth angle out of alignment (i.e., half of the 6.10 degrees (of the illustrative embodiment described above) out of alignment). By allowing for at least 3.05 degrees rotation in adjustable flange 30, adjustable flange 30 may be rotated to the one position that aligns the generator clocking pin 32 of adjustable flange 30 precisely in relation to generator drive spline 28. The accuracy of the alignment may depend on the incremental amount the angular location of alignment holes 40 progressively increases with respect to threaded insert holes 41. Once generator clocking pin 32 has been precisely aligned with generator drive spline 28, this alignment position may be locked to prevent movement of generator drive spline 28 relative to generator clocking pin 32 by installing one alignment bolt 43 thru the single alignment hole 40 that aligns directly with its corresponding threaded insert 41, into the corresponding threaded insert 41. Generator clocking pin 32 may now be at a proper angular position relative to generator drive spline 28. It will be appreciated that the proper angular position may vary from engine to engine and that this value may be known to the skilled artisan. This adjustment may be done during assembly of engine 10. As each of several additional generator drive gears 26 are sequentially installed, they may be properly aligned back to the first generator. After all generators are properly aligned, adjustable flanges 30 for all generators 24 may be set in position by tightening bolts in bolt slots 56 to gearbox 12 and generator 24.

Although represented in FIG. 3 as a round hole, alignment holes 40 may be any shape desired. In an illustrative embodiment, at least one of the alignment holes 40 may be a radial slot 40′ (see FIG. 4). The radial slots 40′ may have a very small width clearance with respect to a diameter of the clocking bolt 43 that fits into the respective threaded insert hole 41, but may have enough radial length to allow for radial positional tolerances of both the radial slot 40′ and the threaded insert holes 41 in gearbox 12. This width clearance with respect to the bolt diameter may be much smaller than what would be required for a rounded alignment hole 40. The reduced clearance of a radial slot 40′ may lessen the amount of circumferential “play” in the final positioning of adjustable flange 30 relative to generator drive spline 28 and further increase the accuracy of alignment.

Adjustable flange 30 may further comprise at least one oil passage 36 disposed through body 31 for passing oil from gearbox 12, through adjustable flange 30, to generator 24. In one illustrative embodiment, adjustable flange 30 may comprise three oil passages, a first oil passage 36, a second oil passage 36c and a third oil passage 36d. Each of passages 36, 36c, 36d may have a “racetrack” shape to allow for movement of adjustable flange 30 during alignment. Oil passages 36a and 36b show the position of the passages. When adjustable flange 30 is adjusted clockwise and counterclockwise, first oil passage 36 will have the positions as shown by oil passages 36a and 36b, respectively. First oil passage 36 may align with a gearbox oil passage 52 in gearbox 12 to allow the passage of oil from gearbox 12 to generator 24. In an illustrative embodiment, first oil passage 36 may be rotatable through an angle of from about ±5.0 degrees to about ±7.5 degrees in either direction with respect to clocking pin 32. First oil passage 36 may be oriented at 90 degrees or 180 degrees with respect to generator clocking pin 32. In one illustrative embodiment, first, second and third oil passages 36, 36c, 36d may be disposed at 180 degrees, 90 degrees and 90 degrees respectively, with respect to generator clocking pin 32. First oil passage 36 may be bordered by an oil passage gasket 54, where oil passage gasket 54 may provide a seal to prevent leakage of oil as oil flows through first oil passage 36. In one illustrative embodiment, oil passage gasket 54 may comprise rubber which may be molded into adjustable flange 30.

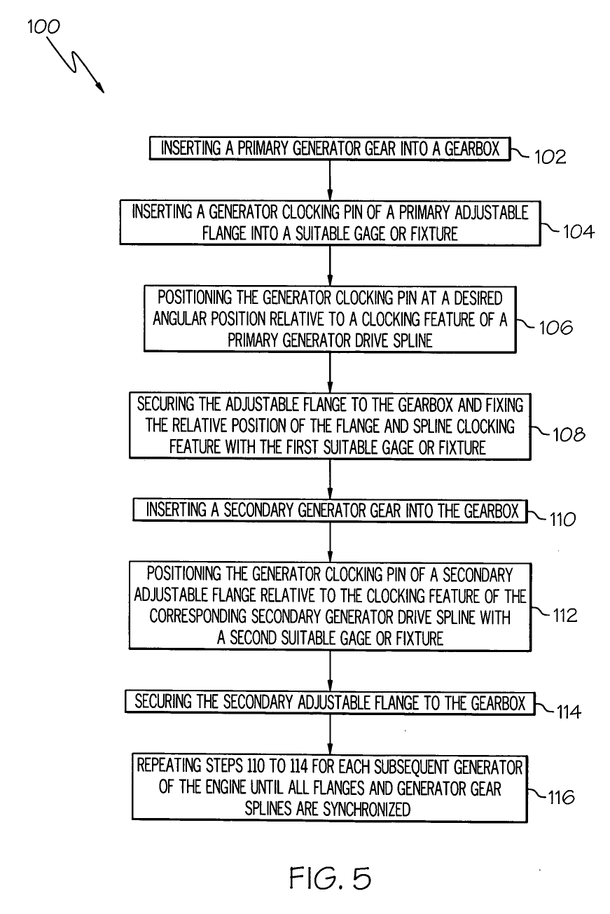

A method for synchronizing multiple generators using the adjustable flange of the present invention is also provided. Referring to FIG. 5, method 100 may comprise step 102 of inserting a primary generator gear into the gearbox by engaging the gear teeth of the gear with the gear teeth of a complementary mating gear, step 104 of inserting a generator clocking pin of a primary adjustable flange into a suitable gauge or fixture and step 106 of positioning the generator clocking pin at a desired angular position relative to a clocking feature of a generator drive spline by rotating the adjustable flange through the use of the suitable gauge or fixture. The generator drive spline may be part of a gearbox of the engine. The adjustable flange may comprise alignment holes which correspond to threaded insert holes on the gearbox, where the alignment holes may each have a different angular position relative to the corresponding threaded insert holes. The adjustable flange may be aligned to the gearbox by rotating the adjustable flange either clockwise or counterclockwise in small, pre-defined increments, as described herein above, e.g., with reference to FIG. 3, until one of the alignment holes aligns with a threaded insert hole.

Method 100 may further comprise step 108 of securing the adjustable flange to the generator housing and the gearbox after obtaining the desired angular position by inserting a single alignment bolt into the one appropriate threaded insert of a series of inserts in the housing and a number of attachment bolts and fixing the relative position of the flange and spline clocking feature with the first suitable gage or fixture. Method 100 may also comprise step 110 of inserting a secondary generator gear into the gearbox by engaging the gear teeth of the secondary generator gear with the complementary mating gear such that the respective spline clocking feature is as close as possible to the desired final angular location. Step 112 may comprise positioning the generator clocking pin of a secondary adjustable flange relative to the clocking feature of the corresponding secondary generator drive spline with a second suitable gage or fixture and step 114 may comprise securing the secondary adjustable flange to the gearbox after obtaining the desired position of the generator clocking pin by inserting a single alignment bolt into one appropriate threaded insert in the housing and a series of attachment bolts. Method 100 may further comprise step 116 of repeating steps 110 to 114 for each subsequent generator of the engine until all generator gears are synchronized.

The accuracy of alignment of one generator to another may be understood to be limited by the physical size of the various features described above and the magnitude of the total adjusting angle required for a particular application. As an example, larger oil passages and the physical size of the adjustable flange 30 and suitable fasteners will combine to limit the maximum number of alignment holes 40 and threaded inserts 41 that can be accommodated. This will obviously limit the minimum value of the incremental adjusting angle and thus the accuracy possible for any given application of this invention.

It should be understood, of course, that the foregoing relates to exemplary embodiments of the invention and that modifications may be made without departing from the spirit and scope of the invention as set forth in the following claims.

We claim:

1. An adjustable flange for synchronizing multiple generators comprising:
a body;
a clocking pin, the clocking pin being attached to the body; and
a plurality of alignment holes, the plurality of alignment holes being disposed circumferentially around the body.

2. The adjustable flange of claim 1 wherein each of the alignment holes has a different off-set angle relative to a corresponding one of a plurality of threaded insert holes on a gearbox, wherein the off-set angle progressively increases by a defined increment for each successive pair of alignment holes and threaded insert holes.

3. The adjustable flange of claim 2 wherein the off-set angle increases by the increment of from about 0.2 degrees to about 0.3 degrees.

4. The adjustable flange of claim 1 wherein at least one of the alignment holes comprises a radial slot.

5. The adjustable flange of claim 1 wherein the adjustable flange comprises 15 of the alignment holes.

6. The adjustable flange of claim 1 wherein the adjustable flange comprises 20 of the alignment holes.

7. The adjustable flange of claim 1 further comprising at least one oil passage disposed through the body of the adjustable flange.

8. The adjustable flange of claim 1 further comprising a plurality of bolt slots, the bolt slots being circumferentially disposed around the body of the adjustable flange.

9. An adjustable flange for synchronizing multiple generators comprising:
a circular body;
a clocking pin, the clocking pin being attached to the circular body;
a plurality of bolt slots, the plurality of bolt slots being disposed circumferentially around the circular body; and
a plurality of alignment holes, the plurality of alignment holes being disposed circumferentially around the circular body.

10. The adjustable flange of claim 9 wherein each of the alignment holes has a different off-set angle relative to a corresponding one of a plurality of threaded insert holes on a gearbox, wherein the off-set angle progressively increases by a defined increment for each successive pair of alignment holes and threaded insert holes.

11. The adjustable flange of claim 10 wherein the adjustable flange comprises from about 15 to about 20 of said alignment holes and wherein the off-set angle increases by the increment of from about 0.2 degrees to about 0.3 degrees. .

12. The adjustable flange of claim 9 further comprising at least one oil passage disposed through the circular body.

13. The adjustable flange of claim 12 wherein the oil passage is located at 90 degrees or 180 degrees relative to the clocking pin.

14. The adjustable flange of claim 12 wherein the oil passage is rotatable through an angle of from about ±5.0 degrees to about ±7.5 degrees with respect to the clocking pin.

15. The adjustable flange of claim 9 wherein the bolt slots are recessed on a forward face of the circular body.

16. An adjustable flange for synchronizing multiple generators comprising:
a circular body;
a clocking pin, the clocking pin projecting axially from a forward face of the circular body;
a plurality of bolt slots, the plurality of bolt slots being disposed circumferentially around the circular body;
a plurality of alignment holes, the plurality of alignment holes being disposed circumferentially around the circular body and wherein each of the alignment holes has a different off-set angle relative to a corresponding one of a plurality of threaded insert holes on a gearbox, wherein the off-set angle progressively increases by a defined increment for each successive pair of alignment holes and threaded insert holes; and
at least one oil passage, the oil passage being disposed through the circular body.

17. The adjustable flange of claim 16 wherein the adjustable flange comprises from about 15 to about 20 of said alignment holes and wherein the off-set angle increases by the increment of from about 0.2 degrees to about 0.3 degrees.

18. The adjustable flange of claim 16 wherein the adjustable flange comprises three oil passages.

19. The adjustable flange of claim 18 wherein the three oil passages comprise a first, second, and third oil passage and the first, second, and third oil passages are disposed at 180 degrees, 90 degrees, and 90 degrees, respectively, with respect to the clocking pin.

20. The adjustable flange of claim 18 wherein the oil passages are rotatable through an angle of from about ±5.0 degrees to about ±7.5 degrees with respect to the clocking pin.

21. The adjustable flange of claim 16 wherein each of the oil passages has a racetrack shape.

22. The adjustable flange of claim 16 wherein at least one of the alignment holes comprises a radial slot.

23. The adjustable flange of claim 16 wherein the adjustable flange comprises from about 6 to about 8 of the bolt slots.

24. The adjustable flange of claim 16 wherein the adjustable flange is part of a gas turbine engine.

25. The engine of claim 24 wherein the engine comprises six generators.
